(19) United States
(12) Patent Application Publication
(10) Pub. No.: US 2024/0334174 A1
(43) Pub. Date: Oct. 3, 2024

(54) METHOD AND APPARATUS FOR HANDLING PROFILE LOADING RESULT IN WIRELESS COMMUNICATION SYSTEM

(71) Applicant: Samsung Electronics Co., Ltd., Suwon-si (KR)

(72) Inventors: Sujung KANG, Suwon-si (KR); Kangjin YOON, Suwon-si (KR); Duckey LEE, Suwon-si (KR)

(21) Appl. No.: 18/622,650

(22) Filed: Mar. 29, 2024

(30) Foreign Application Priority Data
Mar. 29, 2023 (KR) 10-2023-0041081
Jun. 14, 2023 (KR) 10-2023-0076330

(51) Int. Cl. H04W 8/18

(52) U.S. Cl. CPC H04W 8/183

(57) ABSTRACT

The disclosure relates to a 5G or 6G communication system for supporting a higher data transmission rate. The disclosure relates to a method performed by a first device in a wireless communication system, the method comprises transmitting, to a terminal, a first message for a request of a process of a profile, receiving, from the terminal, a second message including a result of the process of the profile, generating a bound profile package (BPP) loading report based on the result of the process of the profile, and transmitting, to a profile server, the BPP loading report, wherein the BPP loading report is generated based on a profile order identity (ID).

### CROSS-REFERENCE TO RELATED APPLICATIONS

This application is based on and claims priority under 35 U.S.C. § 119 to Korean Patent Application No. 10-2023-0041081 filed on Mar. 29, 2023, and Korean Patent Application No. 10-2023-0076330 filed on Jun. 14, 2023, both of which were filed in the Korean Intellectual Property Office, and the disclosures of which are herein incorporated by reference in their entirety.

### BACKGROUND

### 1. Field

The disclosure relates to a method and an apparatus for provisioning a profile in a wireless communication system and, more particularly, to a method and an apparatus for provisioning or deleting a plurality of profiles from embedded universal integrated circuit cards (eUICCs) of UEs in a wireless communication system and providing a processing result thereof.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

An aspect of the disclosure is to provide an apparatus and a method capable of effectively providing a service in a wireless communication system.

According to various embodiments of the disclosure, a method performed by a user equipment (UE) in a wireless communication system includes receiving a first control signal transmitted from a factory IT, processing the received first control signal, and transmitting a second control signal generated based on the processing to the factory IT.

According to various embodiments of the disclosure, a method performed by a first device in a wireless communication system is provided. The method comprises transmitting, to a terminal, a first message for a request of a process of a profile, receiving, from the terminal, a second message including a result of the process of the profile, generating a bound profile package (BPP) loading report based on the result of the process of the profile, and transmitting, to a profile server, the BPP loading report, wherein the BPP loading report is generated based on a profile order identity (ID).

According to various embodiments of the disclosure, a method performed by a profile server in a wireless communication system is provided. The method comprises transmitting, to a first device, a first message including information for installing a profile, receiving, from the first device, a bound profile package (BPP) loading report including a result of a process of the profile, transmitting, to the first device, a response message based on a reception of the BPP loading report and verifying the BPP loading report based on a profile order identity (ID).

According to various embodiments of the disclosure, a first device in a wireless communication system is provided. The first device comprises a transceiver and a controller configured to transmit, to a terminal, a first message for a request of a process of a profile, to receive, from the terminal, a second message including a result of the process of the profile, to generate a bound profile package (BPP) loading report based on the result of the process of the profile, and to transmit, to a profile server, the BPP loading report, wherein the BPP loading report is generated based on a profile order identity (ID).

According to various embodiments of the disclosure, a profile server in a wireless communication system is provided. The profile server comprises a transceiver and a controller configured to transmit, to a first device, a first message including information for installing a profile, to receive, from the first device, a bound profile package (BPP) loading report including a result of a process of the profile, to transmit, to the first device, a response message based on a reception of the BPP loading report, and to verify the BPP loading report based on a profile order identity (ID).

According to various embodiments of the disclosure, a method performed by a factory IT in a wireless communication system includes receiving a first control signal transmitted from a profile server, transmitting the received first control signal to a user equipment (UE) and receiving a result processed by the UE, and transmitting a second control signal generated based on the processing to the profile server.

According to various embodiments of the disclosure, a method performed by a profile server in a wireless communication system includes receiving a first control signal transmitted from a factory IT, processing the received first control signal, and transmitting a second control signal generated based on the processing to the factory IT.

The technical subjects pursued in embodiments of the disclosure may not be limited to the above-mentioned technical subjects, and other technical subjects which are not mentioned may be clearly understood, through the following descriptions, by those skilled in the art to which the disclosure pertains.

According to various embodiments of the disclosure, an apparatus and a method for effectively providing a service in a mobile communication system can be provided.

Advantageous effects obtainable from the disclosure may not be limited to the effects mentioned in various embodiments, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of the relationship between elements for provisioning profiles according to an embodiment of the disclosure.

FIG. 2 illustrates a procedure for returning an installation result when a profile is installed according to an embodiment of the disclosure.

FIG. 3 illustrates in detail a procedure for providing a BPP loading report (BPP) loading report according to an embodiment of the disclosure.

FIG. 4 illustrates a procedure in which a factory profile assistant (FPA) makes a request for and processes cancel during profile loading according to an embodiment of the disclosure.

FIG. 5 illustrates a procedure for preparing the large number of profiles for in-factory profile provisioning (IFPP) according to an embodiment of the disclosure.

FIG. 6 illustrates a procedure for processing, before the FPA transmits a loading message including a BPP to the eUICC, the message transmitted from the FPA to the eUICC according to an embodiment of the disclosure.

FIG. 7 illustrates a block diagram of the structure of a profile server, a factory IT, and a UE in a wireless communication system according to an embodiment of the disclosure.

### DETAILED DESCRIPTION

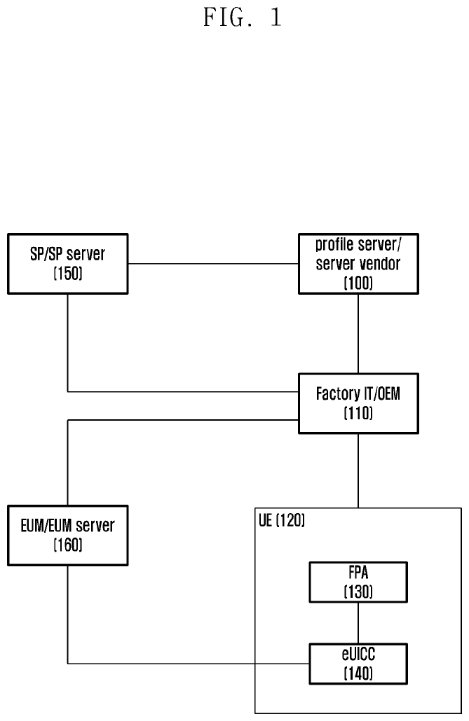

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. It should be noted that, in the drawings, the same or like elements are designated by the same or like reference signs as much as possible. Furthermore, a detailed description of known functions or configurations that may make the subject matter of the disclosure unclear will be omitted.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the term “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card.

In the following description, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smart phone, a computer, or a multimedia system capable of performing a communication functions. Furthermore, embodiments of the disclosure as described below may also be applied to other communication systems having similar technical backgrounds or channel types to the embodiments of the disclosure. In addition, based on determinations by those skilled in the art, the embodiments of the disclosure may also be applied to other communication systems through some modifications without significantly departing from the scope of the disclosure. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

In the following description, terms for identifying access nodes, terms referring to network entities or network functions (NFs), terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

In the following description, some of terms and names defined in the 3rd generation partnership project (3GPP) long term evolution (LTE) standards and/or 3GPP new radio (NR) standards may be used for the sake of descriptive convenience. However, the disclosure is not limited by these terms and names, and may be applied in the same way to systems that conform other standards.

For convenience of the following description, the disclosure uses terms and names defined in remote SIM provisioning (RSP) specifications (SGP.XX series) corresponding to the specifications defined by a global system for mobile communications (GSM) association (GSMA) among the currently existing eSIM standards. However, the disclosure is not limited by the terms and names, and may be equally applied to eSIMs following other specifications. A universal integrated circuit card (UICC) is a smart card used by being inserted into a mobile communication terminal and is also referred to as a UICC card. An access control module for accessing a network of a mobile communication operator may be included in the UICC. Examples of the access control module may include a universal subscriber identity module (USIM), a subscriber identity module (SIM), an internet protocol (IP) multimedia service identity module (ISIM), and the like.

Based on the discussion, the disclosure provides a method and an apparatus for installing profiles in an eUICC of a UE in a factory environment of a manufacturer UE in a wireless communication system.

The disclosure may provide a method and an apparatus for providing a result obtained by effectively processing profiles in one eUICC one or more times in the UE manufacturer factory environment in a wireless communication system.

A UICC including a USIM is generally called a USIM card. Similarly, a UICC including a SIM module is generally called a SIM card. In the following description, it should be noted that the SIM card can be used as a general meaning including a UICC including a UICC card, a USIM card, or an ISIM. The technology of the SIM card may be equally applied to a USIM card, an ISIM card, or a general UICC card.

The SIM card may store private information of a mobile communication subscriber, and authenticate the subscriber and create a traffic security key when the subscriber accesses a mobile communication network, thereby making it possible to safely use the mobile communication.

The SIM card is generally manufactured as a card dedicated for a particular mobile communication operator according to a request from the corresponding mobile communication operator while the SIM card is produced and is released with authentication information for network access of the corresponding operator, for example, a universal subscriber identity module (USIM) application, an international mobile subscriber identity (IMSI), a K value, and an OPc value, installed therein in advance. Accordingly, the manufactured SIM card is received by the mobile communication operator and then provided to a subscriber. Then, an application within the UICC may be managed, for example, installed, modified, and removed using an over the air (OTA) technology as necessary.

The subscriber may insert the UICC card into his/her own mobile communication terminal and use the network of the mobile communication operator and application services. Further, when changing a mobile communication terminal, the subscriber may move and insert the UICC card from the existing mobile communication terminal to a new mobile communication terminal, thereby using the same authentication information, mobile communication phone number, personal phone book, and the like stored in the UICC card in the new mobile communication terminal.

However, SIM card may be inconvenienced when a user of the mobile communication terminal receives services of another mobile carrier. The user of the mobile communication terminal may have inconvenience in that the SIM card should be physically acquired to receive the service from the mobile communication operator. For example, when traveling to other countries, the user may need to obtain a local SIM card in order to receive a local mobile communication service, which inconveniences the user. A roaming service may resolve this inconvenience somewhat, but there are also problems of high fees and lack of service if there is no contract between mobile carriers.

Meanwhile, when the SIM module is remotely download and installed in the UICC card, the inconvenience can be considerably resolved. For example, the user may download the SIM module of the mobile communication service which the user desires to use in the UICC card at a desired time point. The UICC card may download and install a plurality of SIM modules and select and use at least one of the SIM modules. The UICC card may or may not be fixed to the UE. The UICC fixed to the UE is generally an eUICC, and UICC cards that can remotely download and select a SIM module may be collectively called an eUICC. That is, among UICC cards that can remotely download and select the SIM module, UICC cards which are fixed to or not fixed to the UE may be collectively called eUICCs. Further, downloaded SIM module information may collectively use the term profile. Examples of the profile may be further divided according to the use of a provisioning profile corresponding to a profile having use restrictions such as connectivity for initial settings (for example, allow access of the profile server), an operational profile corresponding to a profile having no use restrictions, and a test profile limited for test. The provisioning profile may be used as a term of a bootstrap profile.

In order to install a profile within an eUICC, it is assumed that the UE user downloads the profile through a real-time network connection with a profile download server generally after the UE is released. Currently, according to remote profile provisioning standard specifications corresponding to the eSIM standardized specifications defined in GSMA, for example, SGP.21/22 corresponding to a consumer UE-specific remote SIM provisioning standard, SGP.31/32 corresponding to an IoT UE-specific remote SIM provisioning standard, and SGP.01/02 corresponding to an M2M UE-specific remote SIM provisioning standard, a process in which the UE is connected to the profile download server through the network in real time and the UE and the profile server exchange messages several times and a process in which the profile is downloaded after common mutual authentication during the process may be defined. However, the UE cannot assume a situation in which the network is always connected to the profile download server at a time point at which the profile is downloaded. Accordingly, in order to solve the problem, the provisioning profile corresponding to the profile having the use restrictions to provide connectivity for initial settings to the UE has been introduced to SGP.21/22. Accordingly, the UE manufacturer may also release eUICCs in which provision profiles are installed. Further, the manufacturer can install in advance the operational profile of the communication operator having no use restrictions within the eUICC and release the eUICC, based on contract with the service provider.

Further, after the operator profile is initially installed in the eSIM UE at the factory, supporting an operator order change and release of a UE after the installed profile is changed and re-injected due to a refurbished UE may be needed. Further, supporting provision of mass installation or deletion processing information of the profile generated in an individual UE (FPA or eUICC) to the profile server may be needed. The disclosure may solve the problem.

Meanwhile, a new work item of provisioning a profile in the UE in the factory has been recently approved by the GSM association (GSMA) and discussion on standardization of apparatuses and methods for provisioning the profile in the UE at the factory with SGP.41 (technical requirement specification) and SGP.42 (technical specification (scheduled)) will be made.

In the disclosure, a function for provisioning the profile at the factory may be referred to as an in factory profile provisioning (IFPP) function, and the case of entry into a state where the IFPP function is supported may be expressed as entry into an IFPP mode or an IFPP state. Alternatively, “f” may be additionally added to the end of a name of each entity to indicate a state in which the IFPP mode operates. For example, as a specific entity, a UE, a local profile assistant (LPA), an eUICC, a profile server, a factory IT, a service provider (SP) server, or an eUICC manufacturer (EUM) server may be an entity further supporting the IFPP mode or an entity supporting the IFPP function. For example, SM-DP+ corresponding to one of the profile servers may be a server that supports the consumer-specific remote SIM provisioning function defined SGP.21/22 and further support some of the IFPP functions defined in SGP.41/42. Alternatively, SM-DP+ corresponding to the profile server may be a profile server supporting the IFPP function. The profile server operating in the IFPP state may be expressed as, for example, a profiler server f or SM-DPf in the disclosure.

In the disclosure, the universal integrated circuit card (UICC) is a smart card used while being inserted into a mobile communication UE and may be a chip that stores personal information such as network access authentication information, a phone book, and a short message service (SMS) of a mobile communication subscriber, and authenticate the subscriber and generate a traffic security key when access to a mobile communication system such as GSM, wideband code division multiple access (WCDMA), LTE, or 5G is performed, thereby making it possible to safely use mobile communication. A communication application, such as a subscriber identification module (SIM), a universal SIM (USIM), an IP multimedia SIM (ISIM), and the like may be installed in the UICC according to the type of mobile communication network which a subscriber accesses, and the UICC may provide a higher level security function for loading various applications, such as an electronic wallet, ticketing, an electronic passport, and the like.

In the disclosure, the embedded UICC (eUICC) is not limited to a security module embedded into the UE, and may include a removable security module that can be inserted into and removed from the UE. The eUICC may download and install the profile in real time or non-real time through the wired/wireless network. The eUICC may be named a UICC capable of downloading and installing a profile. When the eUICC installs the profile in a factory environment in which real-time communication with the outside is difficult, the SM-DPf server generating the profile may configure a separate device for injecting the profile into the eUICC wiredly or wirelessly communication by a factory IT/original equipment manufacturer (OEM).

In the disclosure, a method of downloading and installing the profile in the eUICC may be applied to the removable UICC that can be inserted into and removable from the UE as described above. For example, the embodiment of the disclosure may be applied to the removable UICC that can download and install the profile. In the disclosure, an eUICC unique identification information (eUICC ID) may be referred to as an EID. The term UICC in the disclosure may be used interchangeably with the term SIM, and the term eUICC may be used interchangeably with the term eSIM.

In the disclosure, the profile may mean a software format package of an application, a file system, an authentication key, etc. stored in the UICC. Further, the profile may be named access information. In the disclosure, the USIM profile has the same meaning of the profile or may be a software format package of information included in a USIM application within the profile. In the disclosure, the profile package or the encrypted profile package (bound profile package (BPP)) may be interchangeably used with “profile” or may be used as a term indicating a data object of a particular profile, and may be named a profile tag, length, and value (TLV) or a profile package TLV. A profile identifier may be referred to as an integrated circuit card identifier (ICCID) indicating a unique identification number of the profile. When the profile package is encrypted using an encryption parameter, the profile package may be named a protected profile package (PPP) or a protected profile package TLV (PPP TLV). When the profile package is encrypted using an encryption parameter that can be decrypted by a particular eUICC, the profile package may be named a bound profile package (BPP) or a bound profile package (BPP) TLV. The profile package TLV may be a data set indicating information which configures a profile in a tag, length, and value (TLV) format.

In the disclosure, the profile server is a server that generates a profile, encrypts the generated profile, stores the generated profile, generates a profile remote management instruction, provides a function of encrypting the generated profile remote management instruction, or providing an IFPP mode, and may be expressed as subscription manager data preparation (SM-DP), subscription manager data preparation plus (SM-DP+), or subscription manager secure routing (SM-SR). As described above, the profile server that operates by providing the IFPP function may be SM-DPf.

The term “terminal” or “device” used in the disclosure may refer to a mobile station (MS), user equipment (UE), a user terminal (UT), a wireless terminal, an access terminal (AT), another kind of terminal, a subscriber unit, a subscriber station (SS), a wireless device, a wireless communication device, a wireless transmission/reception unit (WTRU), a moving node, a mobile device, or other devices. Various embodiments of the UE may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, music storing and playing home appliances having a wireless communication function, Internet home appliances capable of performing wireless Internet access and browsing, and portable units or UEs having a combination of the functions. Further, the UE may include a machine to machine (M2M) UE, a machine type communication (MTC) UE/device, and an IoT UE/device according to supported capability characteristics. In the disclosure, the UE may be referred to as an electronic device or simply a device. The UE 120 providing a function of installing a profile in the eUICC may be called an eSIM UE.

In the disclosure, the EUM is an eUICC manufacturer and means a manufacturing company that produces an eUICC and personalizes and provides the eUICC, and information transmitted by the EUM may be transmitted online or offline through a channel between an EUM server and a separate element. According to an embodiment of the disclosure, the EUM may the EUM server or the role played by the EUM.

In the disclosure, the UE or the device may include software or an application installed in the UE or the device to control the UICC or the eUICC. The software or application may be an application, for example, a local profile assistant (LPA), a SIM manager, or an IoT profile assistant (IPA). Software or functions may be integrated and provided. For example, the LPA and the IPA may be provided as one integrated app. In the disclosure, the software or applications that are installed in the UE or the device to control the UICC or the eUICC and operates by the IFPP function may be collectively expressed as FPAs or LPAfs.

In the disclosure, an application protocol data unit (APDU) may be a message format or a message exchanged between the controller and the eUICC within the UE or the device. The APDU is a pair of a command and a response, and the APDU command the APDU response may be defined ETSI 102.221 with reference to ISP 7816. As defined in ETSI 102.221, the APDU command may have the structure of class of instruction (CLA), instruction (INS), instruction parameter 1 (P1), and instruction parameter 2 (P2) as the header of the APDU and number of bytes in the command data field (Lc), data, and number of bytes expected in response of the command (Le) as the body, and the APDU response may have the structure of optional data field, status byte 1 (SW1), and status byte 2 (SW2) and refer to ETSI 102.221 specifications for a detailed description thereof. An application message transmitted by the LPA or the UE may be transmitted to the eUICC in an APDU form in which case the transmitted information may be transmitted while being included in data of the APDU.

In the disclosure, AKA may indicate authentication and key agreement, and correspond to an authentication algorithm for accessing 3GPP and 3GPP2 networks. K is an encryption key value stored in the eUICC used for AKA authentication algorithm, and OPc may be a parameter value that may be stored in the eUICC used for the AKA authentication algorithm in the disclosure.

In the disclosure, NAA is a network access application and may be an application such as a USIM or an ISIM stored in the UICC to access the network. The NAA may be a network access module.

In the disclosure, an end user, a user, a subscriber, and a service subscriber may be used interchangeably with a user of the UE.

In the disclosure, the factory IT is a device that serves to process provisioning of specific data or settings in the UE during a manufacturing process and may refer to a module including a function of downloading a profile to the UE and may further include a function of acquiring profiles from the profile server and store the profiles. The factory ID may be a device that may serve to collect profile processing results and transmit the results. The factory IT may be used interchangeably with a factory IT device, a factory IT server, a factory provisioning device, a factory server, an OEM, and a UE manufacturer, and even through the factory IT is expressed as a server hereinafter, the factory IT in the disclosure may be one or more modules, for example, a server for acquiring, collecting, storing, or processing, and transmitting data and a UE for injecting settings or data with an eSIM UE at a contact point or acquiring a processing result.

In the disclosure, the OEM may be used interchangeably with a UE manufacturer and a manufacturer. In the disclosure, some of several devices of the OEM may be connected wiredly or wirelessly to the inside of the manufacturer and may not allow an external network. For example, a data storage server used for a manufacturing process or communication devices for injecting profiles into the UE may not provide the network connection to the outside and may be connected to an internal network. The profile storage server within the manufacturer may be a device that is the same as or different from a server that returns a BPP loading report to the outside. In the disclosure, the factory IT/OEM may be described as one or more devices that install the profile in the UE at a manufacturer factory and return the BPP loading report.

In the disclosure, a BPP loading report and a profile loading report may be described as a report generated by the UE manufacturer, based on collected processing results generated and returned by the eUICC after the UE manufacturer installs profiles acquired from SM-DPf in the UE, deletes the profiles.

In the disclosure, a profile order ID is an identification ID for a specific profile order and may be generated by a communication service operator or a profile server vendor according to a profile order request from the communication service operator and shared with the UE manufacturer. The profile order ID is defined as a unique value between MSP-SM-DPf, and may be used as information by which the SM-DPf can determine which order is mapped to the requested profile through provision of the corresponding profile order ID by the UE manufacturer. The profile order ID may be expressed as, for example, a hexadecimal such as a combination of 0-9, A-Z, and “-”. In the disclosure, the service provider (SP) may be used interchangeably with a communication service operator, a mobile service operator (MSP), a mobile network operator (MNO), a mobile network operator, an operator, a mobile carrier, and an (M)SP server, and the service provider may mean a server of the service provider or the role played by the service provider.

In the disclosure, the server vendor may be a vendor that operates the profile server and mean the role played by the profile server vendor.

In the disclosure, the encryption key is used as the meaning including all of encryption and decryption keys. For example, a private key used for encrypting data and a public key for decrypting the data may be included, and the public key may be shared in a credential form.

In the disclosure, otSK.EUICC.KA or otPK.EUICC.KA indicates a one-time secret key (otSK) of the eUICC defined in SGP.22 or a one-time public key (otPK) of the eUICC, and KA may be key agreement. In the disclosure, a pair of one-time encryption keys or a pair of one-time eUICC encryption keys may be otSK.EUICC.KA and otPK.EUICC.KA. The secret key is used interchangeably with a secret key or a private key, and the public key is used interchangeably with a public key.

In the disclosure, a key material is eUICC information necessarily including otPK.EUICC.KA and further including capability information such as an eUICC credential chain or eUICC info, and may indicate encryption key data information for one-time profile installation in a specific eUICC. In the key material, otPK.EUICC.KA may be transmitted as signed data of the eUICC. In the case of transmission as the signed data of the eUICC, the profile server generating the profile using the signed data may need to verify the signed data by checking whether it has the same root of trust credentials. Hereinafter, in description of the drawings, the key material may be used interchangeably with key information and encryption key information.

The disclosure provides a method and an apparatus for injecting a profile into the UE including the eUICC and releasing the UE.

Specifically, the disclosure provides a method and an apparatus for collecting results obtained by processing the profile at the factory and supporting provision thereof to the profile server. Currently, in SGP.22 or SGP.32, a method of transmitting the profile processing results may be processed according to the assumption that the results are processed in one-to one correspondence and returned based on the real-time connection between the profile server (SM-DP+) and the UE, and accordingly, the large number of profile processing results may be efficiently acquired and transmitted.

Further, currently, exchanging messages in several round trips may be needed between the UE and the profile server (SM-DP+) in order to return the processing results. Since it may be required to rapidly inject profiles into the UEs and acquire the results of the injection during the large number of UE processes due to characteristics of a factory environment and it may be difficult to perform a process of exchanging messages in several round trips including a procedure for the real-time connection between the profile server and the individual UE and mutual authentication, the disclosure provides a method and an apparatus for overcoming the same to rapidly process the profiles in the large number of UEs and acquire the corresponding results. Further, since the real-time connection between the profile server and the UE is not considered, a method of transmitting, verifying, installing profile encryption keys and verifying the installation result considering non-real time between the profile server (for example, SM-DPf) and the eUICC may be needed.

According to various embodiments of the disclosure, the UE manufacturer may install the large number of profiles in the eSIM UE in advance and release the eSIM UE without the real-time connection with the profile server. Further, when the installed profile is changed due to turning back of the UE or a change in the order of the operator, the UE manufacturer may re-inject the profile and support release to efficiently manage stocks. In addition, the UE manufacturer may provide the profile processing in the form of a BPP loading report that can be verified by SM-DPf, and thus may provide transparency about processing results and use the processing results for settlement.

According to various embodiments of the disclosure, the user may directly access the network by purchasing the UE in which the profile has been already installed, which may eliminate the inconvenience of the user having to find and move to Wi-Fi or a mobile communication network in order to download the profile, and thus user convenience can be increased.

According to various embodiments of the disclosure, the communication operator may provide the user with the UE in which a provisioning profile for downloading owned profiles or an operational profile for directly using owned network services has been already installed, thereby enhancing eSIM usage convenience of the user.

The following embodiments describe procedures of injecting and releasing profiles, and it should be noted that the UE user may provision and install the profiles, based on a procedure defined in SGP.21/22 in a general user environment outside the factory at a specific time point after the release. That is, the following embodiments describe provisioning in an environment in which installation is performed at the factory, which does not apparently mean that the profile installation in the general environment after the release from the factory may be impossible.

FIG. 1 illustrates a block diagram of the relationship between elements for supporting in-factory profile provisioning according to an embodiment of the disclosure.

Referring to FIG. 1, a profile server/server vendor (hereinafter, referred to as a profile server or a server vendor) 100 may support a function of generating a profile for IFPP, storing the profile generated for IFPP, or encrypting the profile generated for IFPP. Further, the profile server/server vendor 100 may additionally support a function of generating a profile to be generally used in a field as defined in SGP.22. The profile server/server vendor 100 may support a function of storing the generate” profile. The profile server/server vendor 100 may provide a function of encrypting the generated profile. The profile server/server vendor 100 may include a function of generating a remote profile management instruction (remote profile management: RPM) or encrypting the generated profile remote management. The profile server/server vendor 100 may support a function of transmitting the generated profile to an eSIM UE or another profile storage server. The RPM may collectively refer to a series of procedures for performing functions of installing, activating, deactivating, and deleting a profile, and other functions by an instruction transmitted from the profile server/server vendor 100 to a User equipment (UE) 120. The RPM may be requested by a communication service operator, a service provider, or an owner of the UE, and the instruction may be generated by the profile server/server vendor 100.

The profile server/server vendor 100 may receive a profile order request from a service provider (SP)/SP server (hereinafter, referred to as an SP or an SP server) 150 and determine whether the profile order request is a request for generating the profile for IFPP. The profile server/server vendor 100 may combine profile order information received from a factory IT server/OEM (hereinafter, referred to as a factory IT, a factory server, or an OEM) 110 or the SP/SP server 150 with ordered EID information, and map the profile and the EID to prepare them in the profile server/server vendor 100. The SP/SP server 150 may receive the profile order request received from the factory IT server/OEM 110 and determine whether the profile order request is an order request for providing profiles for IFPP. After the determination, the SP/SP server 150 may order provision of the profiles to the profile server/server vendor 100 and the profile server/server vendor 100 may provide one or more bound profile packages (BPPs) to the factory IT/OEM 110.

The UE 120 may include an eUICC 140 and a communication modem (not shown). The communication modem may include one or more baseband processors (hereinafter, basebands) for wireless communication. The communication modem may be referred to as a communication unit or a transceiver. The UE 120 may provide a function of receiving BPP(s) generated for IFPP from the factory IT/OEM 110 and installing the BPP(s) in the eUICC 140. The UE 120 may transmit the BPP to” the ‘UICC 140 via the FPA 130 or without passing through the EPA 130.

As an example of methods of installing the BPP transmitted to the eUICC 140 by using the FPA 130 and transmitting a message for encryption key information, a method of performing transmission included in one or more message starting with ES10x may be included, but is not limited thereto. In the case of transmission without passing through the FPA, the corresponding message may be transmitted to the body of the data through data of APDU such as STORE DATA.

Meanwhile, although the number of profile server/server vendors 100 is one in FIG. 1, the number of profile server/server vendors 100 may be plural. The factory IT/OEM 110 may receive BPPs from a plurality of profile servers/server vendors 100 and store the same.

As described above, the FPA 130 may be eUICC control software or application supporting an IFPP function. The FPA 130 may be implemented as a logical function of the UE 120 or the eUICC 140. The FPA 130 may receive additional authentication information for authenticating a profile and the profile server/server vendor 100 from the factory IT/OEM 110 and provide the same to the eUICC 140. The FPA 130 may play the role of acquiring a profile installation result from the eUICC 140 and transmitting the same to the factory IT/OEM 110.

The eUICC 140 may determine a request for installing a profile in a factory through one or more message of ES10x received from the FPA 130 or a profile installation message received through an application or software for factory setting of the factory IT 110 or the UE and determine entry into an IFPP mode. If the eUICC 140 does not support the IFPP function (for example, when the eUICC cannot understand the received corresponding function), the eUICC 140 may return an error and end IFPP processing.

The eUICC 140 may process the received request through the FPA 130 and reply to the request. The eUICC 140 may acquire information for authenticating the profile and the profile server/server vendor 100 from the UE 120, decode the profile with pre-stored information for authentication, and install the profile. The eUICC 140 may return the installed result to an element transmitting the request, that is, a specific application of the UE or the FPA 130 of the UE. Further, the eUICC 140 may verify the profile server/server vendor 100 encrypting the profile through signature verification of the element that signed the received message or authenticate the profile server/server vendor 100 transmitting the message. The eUICC 140 may include an embedded UICC controlling authority security domain (ECASD), an eSIM operating platform, or the like which is a space for storing credentials required by security domains of the eUICC 140, for example, a certificate issuer's root public key for verifying an SM-DPf credential of the profile server/server vendor 100, a keyset of an eUICC manufacturer, or the like. Further, some of the FPA functions may be implemented in the eUICC 140.

The factory IT/OEM 110 may include UEs such as one or more servers or PCs as devices playing the role of provisioning a profile in the UE at the factory. The factory IT/OEM 110 may acquire predetermined information on the eUICCs 140 including one-time encryption keys from an EUM/EUM server (hereinafter, referred to as an EUM or an EUM server) 160, transmit all or some of the acquired information to the profile server/server vendor 100, or transmit information for mapping for the EID and the profile to be ordered to the SP/SP server 150. The factory IT/OEM 110 may be a server that stores or manages the received encryption key information and the BPP. The factory IT/OEM 110 may make a request for BPP(s) to be injected at the factory to the profile server/server vendor 100 or acquire the BPP to be installed in the eUICC 140 and data signed by the profile server/server vendor 100 from the profile server/server vendor 100 as a result of the request for the BPP(s). The factory IT/OEM 110 may store the received BPPs and the signed data in the factory IT/OEM 110. The factory IT/OEM 110 may select a BPP mapped to the EID of the target UE in which the profile will be installed from among the received or stored BPPs and transmit the BPP to the UE mapped during a manufacturing setting process. The factory IT/OEM 110 may acquire the processing result from the UE 120 through the FPA 130.

The factory IT/OEM 110 may be a server that plays the role of acquiring the received BPP processing result from the UE 120, storing the corresponding acquired result, processing the corresponding result to generate a BPP loading report, or transferring the generated report to the profile server/server vendor 100.

It should be noted that, since the factory IT/OEM 110 means an operation performed by the UE manufacturer or the factory IT of the UE manufacturer, the factory IT/OEM 110 can be implemented as several devices (for example, UEs such as servers, PCs, or the like) even though the factory IT/OEM 110 is expressed as one entity in the following drawings. Accordingly, for example, it should be noted that a device within the factory IT/OEM 110 connected to the profile server/server vendor 100 and a device of the factory IT/OEM 110 connected to the eSIM UE 120 may be the same devices or different devices. Some of information exchanged among the factor IT/OEM 110, the profile server/server vendor 100, the SP server 150, and the EUM 160 may be shared between entities (that is, a UE manufacturer, a profile server operation vendor, a service operator, and an eUICC manufacturer) that perform the role in other forms such as on/off line channels (for example, email sending or the like) other than message transmission and reception through an interface between servers.

The eUICC manufacturer (EUM) 160 is an eUICC manufacture company and may inject key information for verifying qualification for eUICC authentication into the eUICC 140 and provide the personalized eUICCs 140 to the UE manufacturer. The eUICC manufacturer (EUM) 160 may provide predetermined information on the eUICCs 140 including one-time encryption keys from the eUICC manufacturer (EUM)/EUM server 160 to the factory IT/OEM 110. Further, although not illustrated in the drawings, the predetermined information on the eUICCs 140 including the one-time encryption keys may be transmitted from the eUICC manufacturer (EUM)/EUM server 160 to the profile server/server vendor 100 according to a request from the OEM 110.

The service provider (SP) 150 is an operator that provides a network service using the profile as described above, and the SP/SP server 150 may order profile(s) for the IFPP function to the profile server/server vendor 100 and make the profile server/server vendor 100 generate and prepare the ordered profiles. Further, the SP 150 may generate a profile order ID and provide the same to the profile server/server vendor 100 and the OEM 110. In addition, the SP 150 may receive a processing result from the profile server/server vendor 100 and process additional management for the corresponding profiles in the future.

Hereinafter, the description of the component modules may be applied to the roles and the relationship of modules in drawings below. Further, ordered information as information exchanged between the profile server/server vendor 100, the factory IT server/OEM 110, the EUM/EUM server 160, the SP/SP server 150 among the component modules may be transmitted in other forms such as interworking between a server and an interface of respective entities, email, or the like.

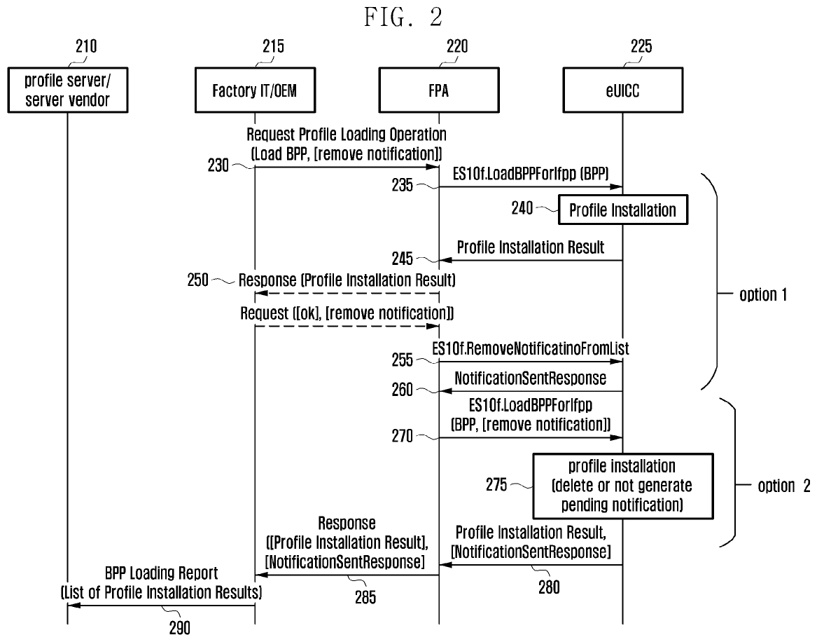

FIG. 2 illustrates a procedure for returning an installation result when a profile is installed according to an embodiment of the disclosure.

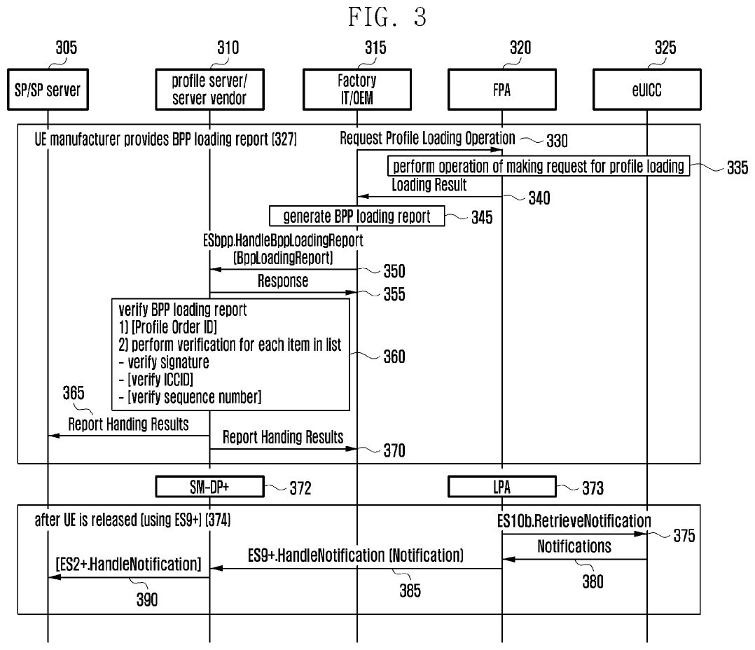

More particularly, FIG. 2 illustrates a detailed procedure for returning an installation result when a profile is installed in FIG. 3 (described below). A procedure which is not mentioned in the drawings may be equally applied with reference with FIG. 3. The description of FIG. 2 may be applied as description of returning the installation result when the profile is installed in various embodiments of the disclosure. FIG. 2 describes in detail the case where a remove notification is made after a profile is installed and a handle notification is not generated in an interface ES9+as described in FIG. 3 below.

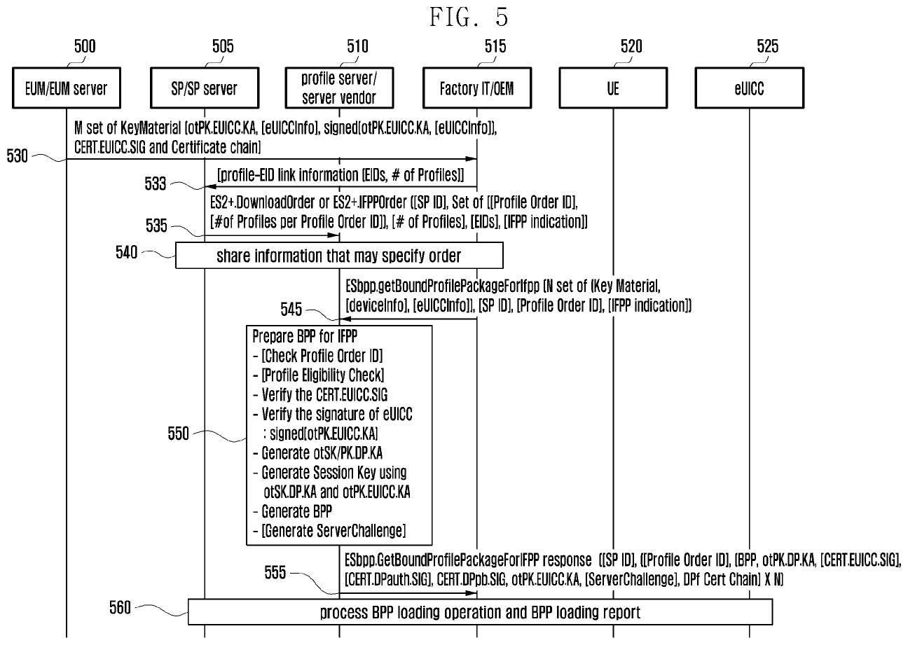

A factory IT/OEM 215 may store and acquire profiles to be loaded from the factory. Acquisition of the profile may follow a procedure described in FIG. 5. The factory IT/OEM 215 may transmit a request or a request message including one or more pieces of information in otPK.EUCC.KA, OtPK.DP.KA, DP credentials, and a credential chain to the UE as a BPP for profile installation in the FPA 220 of the UE and encryption key information for BPP installation in operation 230. Further, the factor IT/OEM 215 may additionally transmit information indicating deletion of the notification after performing an operation for an eUICC request. According to UE settings, the FPA 220 may perform one of the following operations.

Difference between options 1 and 2 below is that the FPA 220 explicitly transmits a message ES10f for a notification deletion request and whether the eUICC 255 processes and replies to the request. Option 1 is an example where the explicit notification deletion request is used, and operation 2 is an example where the explicit notification deletion request is not used.

Option 1-1: the FPA 220 transmits a profile installation request including a BPP in operation 235, first acquires an installation result for the profile installation in operation 245, transmits a notification deletion request generated as the following operation thereof to an eUICC 225 in operation 255, and, when the eUICC 225 processes the deletion according to the received deletion request, FPA 220 receives a message including a result of the deletion processing in operation 260. Thereafter, in operation 285, the FPA 220 may transmit a response message to the factory IT/OEM 215 or an entity corresponding thereto. The response message may include at least a profile installation result and further include NotificationSentResponse.

Option 1-2: the FPA 220 transmits a profile installation request including a BPP in operation 235, first acquires an installation result for the profile installation in operation 245, returns a response thereto to the factory IT/OEM 215 in operation 250, and then acquires an indication for the following operation as a normal response to reception from the factory IT/OEM 215. This may be, for example, a message such as (Request ([ok], [remove notification])). The FPA 220 transmits a notification deletion request generated after receiving the corresponding message to the eUICC 225 in operation 255, and when the eUICC 225 receiving the message processes the deletion according to the received deletion request, FPA 220 receives a message including a result for the deletion processing in operation 260. Thereafter, in operation 285, the FPA 220 may transmit a response message to the factory IT/OEM 215 or an entity corresponding thereto. The response message may include at least one of a profile installation result or NotificationSentResponse. When operation 250 is performed, a notification sent response may be transmitted in operation 285.

Operation 2-1: the FPA 220 transmits the profile installation request including a BPP to the eUICC 225 in operation 235. When receiving a BPP installation request through a function, for example, ES10F making a request for installing the profile at the factory, the eUICC 225 receiving the request transmits the installation result to the FPA 220 in operation 280. The FPA 220 receiving the installation result may complete the operation without additional generation of the notification and transmit the profile installation result to the factory IT/OEM 215 or an entity corresponding thereto in operation 285.

Operation 2-2: the FPA 220 transmits the profile installation request including a BPP in operation 235. When receiving the BPP installation request and the remove notification together through the function, for example, ES10f making the request for profile installation at the factory, the eUICC 225 receiving the request does not additionally generate the notification or generates and then deletes the notification in operation 275 and transmits the profile installation result to the FPA 220 in operation 280. For example, when the notification is generated and then deleted, the eUICC 225 may insert NotificationSentReponse into the profile installation result, and the FPA 220 may transmit a response message including the received result to the factory IT/OEM 215 or an entity corresponding thereto in operation 285. The response message may include at least one of a profile installation result or NotificationSentResponse.

The factory IT/OEM 215 receiving the response message from the FPA 220 may generate a BPP loading report including at least ProfileInstallationResult and transmit the BPP loading report to the profile server/server vendor 210 in operation 290. The profile server/server vendor 210 may verify data of the received message signed by the eUICC and provide a verification result to the SP/SP server and/or the factory IT/OEM 215 (see operations 355 to 370 in FIG. 3 described below).

When the request message for the profile loading operation is transmitted without any additional request for notification deletion in operation 230, the eUICC 225 may individually transfer the remaining notifications to the profile server/server vendor through a function ES9+ defined in SGP.22 after release of the UE (see operation 374 of FIG. 3 described below).

FIG. 3 illustrates in detail a procedure for providing a BPP loading report according to an embodiment of the disclosure.

When a profile is installed or deleted during a UE manufacturing procedure, a UE manufacturer 315 may collect a processing result therefor and provide a BPP loading report to the profile server/server vendor 310. In operation 327, detailed operations therefor are indicated by operations 330 to 370.

In the drawings, for distinction, an SM-DPf may be used when an IFPP function is used, and an SM-DP+ 372 is used when an operation of SGP.22 is performed after the release of the UE for the profile server/server vendor 310. Further, an FPA 320 may be used when the UE uses the IFPP function, and an LPA 373 may be used in accordance with operation of SGP.22.

The factory IT/OEM 315 may transmit a profile loading processing request message to the FPA 320 in operation 330. This may be, for example, a request for installing the profile and transmitting a trigger of an eUICC memory reset. The FPA 320 receiving the corresponding request performs the requested operation in operation 335 and transmits a processing result to the factory IT/OEM 315 in operation 340.

For example, according to the content in the profile loading processing request in operation 330, one of the following information may be returned.

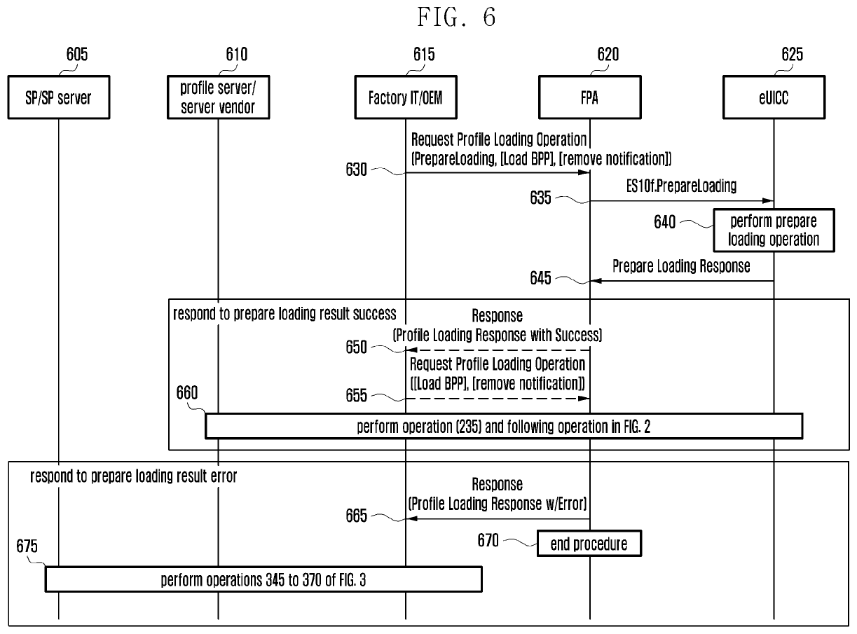

In the case of a profile installation request, one of a profile installation result (including or not including eUICC credential information), a cancel session response, or a prepare loading response or a prepare loading response error described below in FIG. 6

In the case of an eUICC memory reset, other signed notifications

Since definition of the profile installation result and other signed notifications is predefined in the GSMA SGP.22 specifications, a separate description is not made. The factory IT/OEM 315 may collect the processing result received from each UE, classify the result according to each SM-DPf, collect lists of the corresponding values, and generate a BPP loading report in operation 345. In order to classify the processing results according to each SM-DPf, the factory IT/OEM 315 may store information indicating a profile order ID for grouping each of the collected profile installation result, cancel session response, prepare loading response (with error), and other signed notifications, group them by the profile order ID, and transmit them to the profile server/server vendor.

Meanwhile, an address of the SM-DPf to which the processing result is transmitted as predetermined information for classification may be included in a profile installation result, a cancel session response, a prepare loading response (with error), or other signed notifications, and received by the factory IT/OEM 315. This may be received by ServerAddress or notification Address. If the corresponding information is included and received, the factory IT/OEM 315 may acquire the corresponding information and use the same as predetermined information for classification. In the case of the other signed notifications, the eUICC 325 may acquire ServerAddress or notification Address as information in metadata of the profile received together through the BPP and additionally return the same when the corresponding notification is generated, and thus the FPA 320 receiving the address may transfer the address to the factory IT/OEM 315 and the factory IT/OEM 315 may receive the address. Meanwhile, before operation 330, ServerAddress or notification Address may be received by the factory IT/OEM 315 from the profile server/server vendor 310 as signed information of the profile server or non-signed information. The factory IT/OEM 315 may transfer the information to the eUICC 325 through the FPA 320 in operation 335. This may be transmitted, for example, while being included in a message of ES10f.PrepareLoading. When the eUICC 325 acquires the corresponding information, the eUICC 325 may transmit a response including the information when a processing result in the corresponding RSP session, a profile installation result, a cancel session response, and a prepare loading response (with error) are generated, and the FPA 320 may transmit a response including the same again in operation 340. When ServerAddress or notification Address is received by the factory IT/OEM 315 as non-signed information of the profile server through a message received from the profile server/server vendor 310, the factory IT/OEM 315 may have ServerAddress or notification Address without transmission in operation 330 and refer to and use the same in operation 345.

The factory IT/OEM 315 may additionally transmit a shared profile order ID when ordering the corresponding profile before the BPP loading report. At least one of a profile installation result list, a cancel session response list, other signed notification lists, and a prepare loading response (with error) list may be included in the BPP loading report and transmitted. This may be expressed, for example, in a data format shown in [Table 1] below.

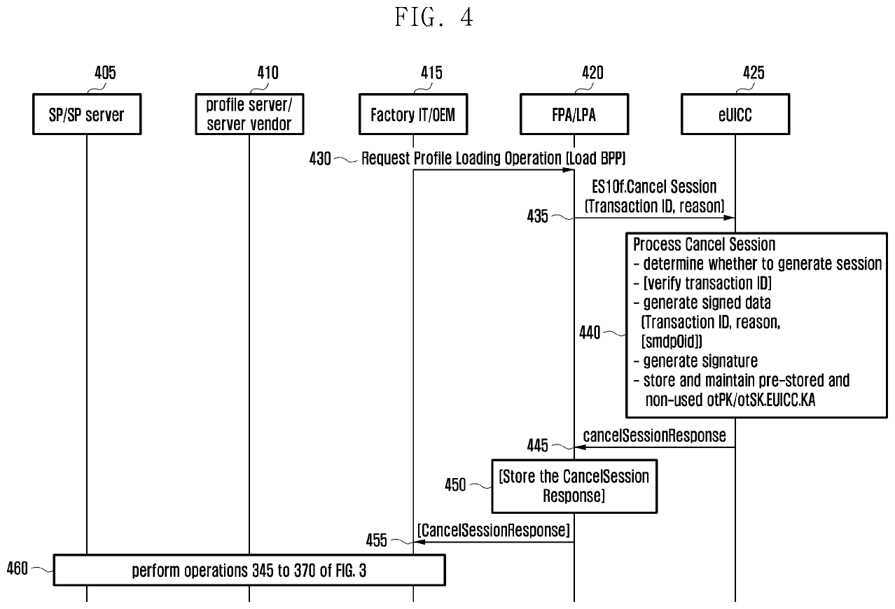

TABLE 1
--ASN1START
HandleNotification ::= SEQUENCE {
profileOrderId OctetTo16, -- Each unique Profile Order ID per MSP
profileInstallationResultList SEQUENCE OF ProfileInstallationResult OPTIONAL, --
data format defined in SGP.22[2]
otherSignedNotificationList SEQUENCE OF OtherSignedNotification OPTIONAL, --
data format defined in SGP.22[2]
CancelSessionResponseList SEQUENCE OF CancelSessionResponse OPTIONAL, --
defined in FIG. 4 by way of example
PrepareLoadingResponseErrorList SEQUENCE OF
PrepareLoadingResponseError OPTIONAL - defined in FIG. 6 by way of example
}
--ASN1STOP

Meanwhile, the FPA 320 may receive the profile installation result and transmit the retrieve notification message to the eUICC 325 again, and the eUICC 325 may acquire the stored pending notification, that is, the profile installation result in the form of other SignNotification including eUICC credential chain information and transmit the profile installation result to the profile server/server vendor 310 according to settings of the factory IT/OEM 315.

The factory IT/OEM 315 may transmit the generated BPP loading report to the profile server/server vendor 310. This may be, for example, a function such as ESbpp.HandleBppLoadingReport (BppLoadingReport). The profile server/server vendor 310 receiving the BPP loading report may return an acknowledgement notification for reception in operation 355. The profile server/server vendor 310 may perform a verification procedure for the BPP loading report in operation 360. Before starting or during the BPP loading report verification procedure, the profile server/server vendor 310 may transmit a response message for acknowledgement notification for message reception according to operation 350 to the factory IT/OEM 315 in operation 355.

The profile server/server vendor 310 may perform an operation including one or more procedures containing at least the verification of the signature of the eUICC for the received BPP loading report.

When the profile order ID is received, validity of the profile order ID may be verified and, when an unknown or invalid profile order ID is received, the profile server/server vendor may not verify each item in the received list.

When reception is performed without profile order ID, the profile server/server vendor 310 may return an error to the factory IT/OEM 315 as the processing result of the corresponding report in operation 370 and may not perform the following procedure.

The profile server/server vendor 310 may verify each item included in the list. When the corresponding item is a cancel session response, an ICCID and a sequence number may not be verified.

Signature verification: when the signature of the eUICC for a profile installation result, a cancel session response, or a prepare loading response error is verified, transmission may be performed without eUICC credentials and credential chain information. When transmission is performed without corresponding information, the profile server/server vendor 310 may perform verification using the eUICC credentials and the credential chain provided by the factory IT/OEM 315. This may be transmitted, for example, while being included in a profile request from the factory IT/OEM 315 as described (in operation 645) in FIG. 5, and the profile request may be a function such as ESbpp.GetBoundProfilePackageForlfpp.

When other signed notifications are received, verification may be performed using the eUICC credentials and the credential chain information received together.
ICCID verification: when the profile server/server vendor 310 has EID information, it may be verified whether the received ICCID is installed in the EID mapped thereto when the profile installation result or other signed notifications are received.
Sequence number verification: verification may be performed when the profile installation result or other signed notifications are received as defined in SGP.22.
Meanwhile, when the RSP server address or the notification address is received as information signed by the eUICC, the profile server/server vendor 310 may verify whether the corresponding information is the same as its own server address.

Meanwhile, identification/verification of the profile order ID may be performed after message reception in operation 350 before operation 360, and the profile server/server vendor 310 may insert the corresponding result into the response in operation 355 and transmit the response to the factory IT/OEM 315. When the error for the profile order ID is received, the factory IT/OEM 315 may re-identify/correct the profile order ID and transmit the message of operation 350 again.

After receiving the BPP loading report in operation 350 or after verifying the BPP loading report in operation 360, the profile server/server vendor 310 may end RSP sessions for the received lists to delete the transaction ID generated for the corresponding RSP session and/or encryption key information used for the corresponding RSP session.

The profile server/server vendor 310 may transfer the BPP loading report verification result to the SP/SP server 305 and/or the factory IT/OEM 315 in operation 365 and operation 370. The corresponding verification result may be ES2+.HandleNotifications (HandleNotifications) defined in GSMA SGP.22 corresponding to the number of lists called by the profile server/server vendor 310 or transmitted in a data format including the list of HandleNotification. The verification result may include a profile installation result.

According to reception of the profile installation result, the SP/SP server 305 and the factory IT/OEM 315 may perform operations such as profile processing state update or the like.

When the UE is released, the UE may perform the following operation according to the operation defined in the SGP.22 specifications of GSMA. Notifications may be transmitted to the SM-DP+ 372 according to the handle notification defined in SGP.22 after the UE is released. This may be generated even in the case where the factory IT/OEM 315 allows the FPA 320 not to make a remove notification to the eUICC 325 before the factory IT/OEM 315 releases the UE.

Alternatively, the factory IT/OEM 315 may replace and provide the BPP loading report without providing the BPP loading report.

The factory IT/OEM 315 allows the FPA 320 to make the remove notification to the eUICC 325 before the factory IT/OEM 315 releases the UE. For example, in operation 340, right after the factory IT/OEM 315 receives the profile installation result or receives OtherSignedNotification, the factory IT/OEM 315 may transmit a message for notification deletion to the FPA 320 and process the deletion. In another example, the factory IT/OEM 315 may provide an indication in operation 330, and the FPA 320 may receive a response message from the eUICC 325 as the result of the operation of installing or deleting the profile in operation 335 and then the FPA 320 can indicate processing of the deletion to the eUICC 325. Alternatively, the eUICC 325 operating in a factory setting mode may install or delete the profile through ES10f and transmit a response message, and then the eUICC 325 can delete the profile by itself.

After the UE is released, the notifications may be transmitted through ES9+ according to a method defined in SGP.22 in operation 374. For example, during an initial booting process after the UE is released, the LPA 323 may perform ES10b. RetrieveNotification through UE settings in operation 375. At this time, when the eUICC 325 does not separately manage pending notifications generated during the IFPP process (for example, using another response data name), the eUICC 325 may return all of the pending notifications generated during the IFPP process to the LPA 373 without separation in operation 380. The LPA 373 may acquire and sort the pending notifications received from the eUICC 325 and transmit a message including the pending notifications to the profile server. The profile server may be SM-DP+ in operation 385. The message may be ES9+.HandleNotification (pending Notification). The SM-DP+ 372 may verify data and transmit a message including the verification result to the SP/SP server 305 in operation 390. The message may be ES2+.HandleNotification.

FIG. 4 illustrates a procedure in which the FPA makes a request for and processes cancel during profile loading according to an embodiment of the disclosure.

An installation error may occur during a process of receiving (operation 430) and processing a profile in a UE manufacturing procedure. This may be an error occurring in the eUICC 425 or an error occurring in the FPA 420 during a process of receiving and processing BPP. An example in which the FPA 420 generates an error during a BPP installation process may be the case where an error occurs during a BPP segmentation process in order to segment and transmit the received BPP to LoadBoundProfilePackageForIfpp by the FPA 420.

The FPA 420 may acquire a signature of the eUICC for the BPP installation error generated during a process of installing the bound profile package and provide the signature to the factory IT/OEM 415 and/or transmit a command or a command message to the eUICC 425 to discard the RSP session of the eUICC due to the corresponding BPP installation error in operation 435. For example, the command may be a function such as ES10f.CancelSession. The command message may include at least one of a transaction ID and an error reason.

The FPA 420 has received the BPP, but may transmit a cancel session to the eUICC 425 before transmitting LoadBoundProfilePackageForIfpp.

The eUICC 425 receiving a message for the cancel session may process the cancel session, including one or more of the following procedures in operation 440 and transmit the corresponding result to the FPA 420 in operation 450.

Determines whether there is an RSP session. Whether there is the RSP session may be determined according to whether the eUICC 425 received a transaction ID for corresponding profile installation before a function call. When there is no previously received transaction ID, the eUICC may sign the received data and return the data without returning an error for the invalid transaction ID. When the previously received transaction ID is received, the eUICC 425 may compare the received transaction ID with the previously received transaction ID and, when the transaction IDs are different, return an error for the invalid transaction ID. For example, when the eUICC 425 determines LoadBoundProfilePackageForIfpp as the start of the RSP session, the transaction ID may be received while being included in LoadBoundProfilePackageForIfpp in which case the eUICC may perform comparison and verification therefor with the previously received transaction ID.

Generation of signed data: generates data to be signed by the eUICC 425, including data received by the FPA 420. When the eUICC 425 does not an object ID (smdpOid) of the SM-DPf before the function call, the eUICC 425 may generate data without adding the smdpOid. Since smdpOid is received while being included in DPf credentials, an example of the case where the SM-DPf does not receive the object ID (smdpOid) before the function call may be the case where the eUICC 425 receives a cancel session before receiving the function call (for example, LoadBoundProfilePackageForIfpp) including SM-DPf credentials (CERT.DPpb.SIG or CERT.DPauth.SIG) from the FPA 420.

Generation of a signature: signs signed data with a private key of the eUICC

When the RSP session is discarded due to reception of the cancel session, the eUICC 425 may store pre-provisioned keys including otPK.EUCC.KA and otSK.EUICC.KA used for the corresponding RSP session without discarding the keys.

The eUICC 425 may configure and return a cancel session response of a cancel session processing result message. This is only an example and may be expressed in data forms shown in [Table 2] and [Table 3] below.

TABLE 2

```
-- ASN1START
CancelSessionRequest ::= SEQUENCE {
  transactionId TransactionId, -- generated by the SM-DPf
  reason CancelSessionReason
}
CancelSessionReason ::= INTEGER {
  loadBppExecutionError(5),
  undefinedReason(127)
}
-- ASN1STOP
```

```
TABLE 3
-- ASNISTART
CancelSessionResponse ::= [65] CHOICE { -- Tag ‘BF41’
  cancel SessionResponseOk CancelSessionResponseOk,
  cancel SessionResponseError INTEGER {invalidTransactionId(5),
undefinedError(127)}
}
CancelSessionResponseOk ::= SEQUENCE {
  euiccCancelSessionSigned EuiccCancelSessionSigned,
  euiccCancelSessionSignature [APPLICATION 55] OCTET STRING
}
EuiccCancelSessionSigned ::= SEQUENCE {
  transactionId TransactionId,
  smdpOid OBJECT IDENTIFIER OPTIONAL,
  reason CancelSessionReason
}
-- ASN1STOP
```

The FPA 420 receiving the response may transmit a cancel session response to the factory IT/OEM 405 in response to the profile loading operation (operation 430) previously received from the factory IT/OEM 415 in operation 455. Alternatively, the FPA 420 may store the corresponding cancel session response in operation 450 and then provide the cancel session response at a time point requested by the factory IT/OEM 415. Further, the FPA 420 may provide information requested to be reported through operation 430 in response to the message of operation 430 according to the content of cancel session processing, store other information, and provide the information at a time point requested by the factory IT/OEM 415.

Thereafter, the factory IT/OEM 415 may transmit the corresponding cancel session responses to the profile server/server vendor 410 and thus the corresponding profile server/server vendor 410 may provide the processing result to the SP/SP server 405 and/or the factory IT/OEM 415 in operation 460. Operation 460 may correspond to the operations 345 to 370 in FIG. 3. For a detailed description thereof, refer to FIG. 3 through the same application of FIG. 3.

FIG. 5 illustrates a procedure for preparing the large number of profiles for IFPP according to an embodiment of the disclosure.

More particularly, FIG. 5 illustrates an example of an operation in which profiles are prepared in the factory IT/OEM 315 before FIG. 3. Referring to FIG. 5, a factory IT/OEM 515 that desires to install eUICCs may order the eUICCs to an EUM/EUM server 500. The EUM 500 may make in advance a pair of otSK.eUICC.KA and otPK.eUICC.KA used by the eUICC and transmit information including the otPK.eUICC.KA to the factory IT/OEM 515 in operation 530. For example, when delivering the eUICC in which otSK.EUICC.KA is installed, the EUM 500 may also transmit at least one of otPK.EUICC.KA, [Euicc info], [EID], credentials of EUICC (CERT.EUICC.SIG), a credential chain, an EID, or PK.EUICC.KA to the factory IT/OEM 515 in operation 530. Among them, otPK.EUICC.KA or the eUICC credentials may be transmitted as eUICC-signed data. Transmitted information may be transmitted through an interface linked with the factory IT 515 from the profile server. The transmitted information may be transmitted online or offline. Each piece of the transmitted information may indicate the following information. Of course, the transmitted information is not limited to the following examples and may include other information.
otPK.EUICC.KA: One-time public key of eUICC

A public key used for generating a session key between the profile server and the eUICC
SK (data including otPK.EUICC.KA): data including otPK.EUICC.KA signed by secret key of eUICC
CERT.EUICC.SIG and credential chain: chain of eUICC credentials and credentials for verifying eUICC credentials
CERT.EUICC.SIG may include a public key (PK.EUICC.KA) for decrypting an EID corresponding to a unique identification number of the eUICC and a eUICC signature. CERT.EUICC.SIG may be used to prove whether the eUICC is authenticated by the EUM.
A higher credential chain of CERT.EUICC.SIG may include CERT.EUM.SIG corresponding to credentials including an EUM public key. When the same credential chain is used for specific eUICC orders, the higher credential chain of CERT.EUICC.SIG may be transmitted for the order rather than for each eUICC.
eUICC info: information on an eUICC capability, and may or may not include an indication for a capability indicating whether the eUICC is an eUICC supporting IFPP. When the same eUICC capability is used for specific orders, eUICC info may be transmitted for the order rather than for each eUICC. As described above, information on whether installation of a plurality of profiles is supported and a method of supporting installation of a plurality of profiles may be further included and transmitted.
EID: unique identification number allocated to each eUICC
PK.EUICC.KA: when a public EID of the eUICC or PK.EUICC.KA for decrypting the eUICC signature is transmitted, a value may be transmitted while being included in CERT.EUICC.SIG or may be transmitted through a separate parameter when it is not included in CERT.EUICC.SIG.

The factory IT/OEM 515 receiving the transmitted information stores the information. At a specific time point, the factory IT/OEM 515 may determine installation of the profiles in N eUICCs which are some of the M eUICCs ordered by the EUM 500 or in all eUICCs. Alternatively, the SP/SP server 505 may make a request for first installing the profiles in the UEs 520 to be released to the factory IT/OEM 515.

The factory IT/OEM 515 may transmit at least one piece of information on the number of profiles and EID(s) to the SP/SP server 505 in order to allow the SP/SP server 505 to prepare profiles linked to the EID as an optional procedure in operation 533.

The SP/SP server 505 may order profiles to the profile server/server vendor 510 in operation 535.

When the SP/SP server 505 acquires and has EID lists at operation 533 or at a previous specific time point, the SP/SP server 505 may order profiles, including EID information to the profile server/server vendor 510. A profile order message may be defined in the form further including IFPP order identification information in an ES2+ order interface between the service provider and the profile server defined in a new function or the existing GSMA RSP. Information included in the order message may include at least one piece of the following information. Of course, the information included in the order message is not limited to the following information and does not exclude inclusion of other information.
A profile order ID indicating a group of order profiles
The number of profiles allocated to each profile order ID or ICCID lists
The number of order profile(s)
ICCID(s)
EID(s) required to be linked to profiles
Service provider (SP) ID: A profile server address to prepare order profiles (for example, fully qualified domain name (FQDN) type address)
IFPP order identification (IFPP indication)
A factory IT serial number to transmit the generated BPP
An OEM identification number (generator number) to transmit the generated BPP

The IFPP indication may be transmitted while being included in a value of IFPP indication data. Alternatively, the Profile OrderID may be transmitted while being included in one of values of profile type data of the ES2+ order interface.

The profile server/server vendor 510 may be a profile server supporting the IFPP, but may be a profile server supporting the IFPP as one of the functions of the server. For example, the profile server/server vendor 510 may be a server supporting SGP.21/22 defined in the GSMA (specification for provisioning the profile in a consumer UE such as a smartphone or the like). Alternatively, the profile server/server vendor 510 may be a profile server supporting SGP.31/32 (specification for provisioning the profile in an IoT-specialized UE). The profile server/server vendor 510 may be a server that does not additionally support a function for provisioning the profile in a factory.

The profile server/server vendor 510 receiving a profile download order may determine whether there is IFPP determination information through a new function defined as IFPPorder or a new parameter of the existing ES2+.Downloadorder, identify whether the profile download order is for IFPP, and manage the same. Identifying whether the profile download order is for IFPP may be based on the IFPP indication or the profile ID. Meanwhile, when the EID is not received in operation 535, the profile server/server vendor 510 may change a state of the profile to an allocated state and process the profile. When the EID is received in operation 535, the profile server/server vendor 510 may connect the EID with the ICCID, change the state of the profile to a linked state, and prepare the profile.

In the future, the profile server/server vendor 510 may receive a request for providing the profile from the factory IT/OEM 515 in operation 545. According to an embodiment of the disclosure, the SP/SP server 505 or the profile server/server vendor 510 may share information that can specify the profile download order to the factory IT/OEM 515 in operation 540.

When the profile server/server vendor 510 receives the request for providing the profile for IFPP from the factory IT/OEM 515, the profile server/server vendor 510 may identify which order corresponds to the request among profile generation orders previously requested by the SP. Information for identifying the order corresponding to the request may include at least one of a profile OrderID, an address of a server storing the profile, service operator identification information making a request for generating the profile, information such as start and end numbers of an ordered profile list, or an EID list, an ordered profile list, an EID list, and a factory IT identification number. In an embodiment of the disclosure, the profile order ID is described as an example of the information for identifying the order in the drawing and the following other examples. The information for identifying the order is not limited to the profile order ID.

Thereafter, when receiving profile request information from the factory IT/OEM 515 in operation 545, the profile server/server vendor 510 may identify selectively included order identification information, and when there are prepared profiles in the selected included order, encrypt the prepared profiles with otPK.EUICC.KA corresponding to the eUICC during a procedure described below and prepare BPPs.

In operation 545, the factory IT/OEM 515 may desire to release UEs after injecting profiles to the UEs before the UEs are released from the factory. To this end, the factory IT/OEM 515 may make a request for BPPs prepared for IFPP to the profile server/server vendor 510.

Methods by which the factory IT 515 indicates an IFPP request to the profile server/server vendor 510 may include at least one of transmitting a message through a new function indicating a BPP request for IFPP, transmitting an IFPP identification indication by using the existing ES9+. function, or transmitting a parameter that may be required for IFPP (for example, information on at least one of otPK.eUICC.KA, Profile order ID, or SP ID). The methods of indicating the IFPP request to the profile server/server vendor 510 may be determined by the profile server/server vendor 510. An example of using the ES9+. Function defined in the existing SGP.22 may be a message such as ES9+. GetBoundProfilePackage including the IFPP identification indication. Meanwhile, the factory IT/OEM 515 may insert key information including otPK.EUICC.KA corresponding to eUICCs of target UEs corresponding to the number of UEs in which the service provider (SP) 505 installs profiles among key information of eUICCs acquired in operation 530 into one piece of data of a series of follow-up messages accompanying the BPP request for IFPP or the BPP generation request and transmit the data to the profile server/server vendor 510. Further, the factory IT/OEM 515 may selectively insert device info as a capability of the UE or eUICC info as eUICC capability information into one piece of data of a series of follow-up messages accompanying the BPP generation request transmitted to the profile server/server vendor 510 and transmit the information as additional information provided for generating the BPP.

When the profile server/server vendor 510 receives a message for determining the BPP request for IFPP from the factory IT 515 and receives key information for otPK.eUICC.KA, the profile server/server vendor 510 may determine BPP preparation for IFPP and perform an operation of generating the BPP for IFPP in operation 550. The profile server/server vendor 510 may enter a procedure of generating the BPP which is an encrypted profile package in the IFPP mode. The case where the profile server/server vendor 510 makes a decision about the generation of the BPP for IFPP may include the case where information for recognizing the generation (for example, information including at least one of a new function defined for IFPP, a new IFPP indication for recognizing a profile download request in a factory through the existing ES9+ message, or a new parameter (encryption key information or the like) is received through the message received from the factory IT 515. When the profile server/server vendor 510 determines to generate the BPP for IFPP, the profile server/server vendor 510 may generate the BPP for IFPP including one or more of the following procedures. Of course, the procedures are not limited to the following examples.

When there is a profile order ID, it may be verified whether the profile order ID is an already known valid profile order ID.

### Profile Eligibility Check

This may be selectively performed as a procedure in which the profile server/server vendor 510 identifies whether a profile type received through an ES2+ order interface from the SP is suitable for being installed in a target UE/EID before profile download. When at least one of the EID, eUICC info, and device info is received through operation 535 to operation 545, procedure of identifying whether a profile order received in operation 550, specifically, a profile type specified in the order can be installed may be selectively (optionally) performed. Accordingly, the profile server/server vendor 510 may or may not verify qualification, including verifying whether the UE is an EID/UE in which the profile for IFPP can be installed.

Verify CERT.EUICC.SIG Corresponding to Credentials of the eUICC

Verification may be performed when the profile server/server vendor 510 receives CERT.EUICC.SIG in operation 545. The profile server/server vendor 510 may verify CERT.EUICC.SIG received in operation 545 with credentials of the EUM. For example, CERT.EUICC.SIG may include an EID, and the EID may include a series of numbers having one of EINs within the EUM credentials. The profile server may identify whether the EID included in CERT.EUICC.SIG matches one of values of allowed EINs (EUM identification IDs) included in CERT.EUM.SIG corresponding to the EUM credentials.

Verify a Signature of the eUICC

The profile server/server vendor 510 may verify a signature by decrypting a secret key of the eUICC used for signing data including otPK.EUICC.KA with a public key of the eUICC included in CERT.EUICC.SIG.
otSK/PK.DP.KA: generates a pair of a one-time secret key and a public key of the profile server
generate a session key with otSK.DP.KA and otPK.EUICC.KA received in operation 545

The profile server/server vendor 510 may generate a shared secret value to be used for a specific profile transmission session by using otSK.DP.KA and otPK.EUICC.KA.

### ServerChallenge

When the factor IT/OEM 515 makes a request for transmission including ServerChallenge information to the profile server/server vendor 510 in operation 545 or before operation 545, the profile server/server vendor 510 may generate ServerChallenge information. When the eUICC 525 is designed to transmit the ServerChallenge value which the profile server/server vendor 510 transmits to the eUICC 525 during a mutual authentication procedure between the profile server/server vendor 510 and the eUICC 525, the eUICC 525 may provide the ServerChallenge value.

### Generates a Bound Profile Package (BPP)

The profile server/server vendor 510 may generate a profile package bound with an EID including a session key, a key change package, and ISD-P generation and configuration information.

When the profile server/server vendor 510 successfully generate the BPP for IFPP in operation 550, the profile server/server vendor 510 may transmit a series of pieces of information required for the BPP and BPP installation to the factory IT/OEM 515 in operation 555. The profile server/server vendor 510 may transmit the series of pieces of information required for the BPP and BPP installation to the factory IT/OEM 515 through one or more messages in operation 555. If the factory IT 515 registers a push service in the profile server/server vendor 510 at a time point at which the BPP request is made, the series of pieces of information required for the BPP and BPP installation may be transmitted while being included in a push message at a time point at which the profile server/server vendor 510 prepares the information, or the profile server/server vendor 510 may inform that the profile is prepared through the push message and the factory IT 515 may access the profile server/server vendor 510 to acquire the profile.

The profile server/server vendor 510 may transmit the generated BPP and a series of encryption key information lists required for verifying the BPP by the mapped eUICC to the factory IT/OEM 515 through one or more messages. Encryption key information, for example, public keys may be transmitted while being included in credentials or may be transmitted without being included in credentials. Information transmitted by the profile server/server vendor 510 may include order identification information, for example, a profile order ID. According to an embodiment of the disclosure, information transmitted by the profile server/server vendor 510 may include data formats such as ESbpp.GetBoundProfilePackageForIFPP response ([SP ID], ([Profile Order ID], (BPP including otPK.DP.KA, [CERT.EUICC.SIG], [CERT.DPauth.SIG], CERT.DPpb.SIG, [ServerChallenge], [otPK.EUICC.KA], DPf Cert Chain)×N). When the profile server/server vendor 510 generates the BPP, a message may be configured and transmitted in a format in which at least one of [CERT.EUICC.SIG], [CERT.DPauth.SIG], CERT.DPpb.SIG, [ServerChallenge], [otPK.EUICC.KA], and DPf Cert Chain is additionally included in the BPP. Alternatively, at least one of CERT.DPauth.SIG], CERT.DPpb.SIG, and DPf Cert Chain may be transmitted one time, rather than N times, per profile order ID corresponding to order identification information of the ordered eUICCs.

The information transmitted in operation 555 may be configured as one message or one or more messages and transmitted to the factory IT/OEM 515, and the factory IT 515 may store the information received in operation 555.

The factory IT 515 may map and store the received BPP, the EID mapped for each BPP, and encryption key information for downloading and installing the BPP, and then perform an operation of installing the BPP at a specific time point like operation 560 or deleting the BPP after installation for corresponding N UEs 520 and process an operation of generating a BPP loading report. For a detailed operation of operation 560, refer to the description of FIG. 3.

FIG. 6 illustrates a procedure for processing, before the FPA transmits a loading message including a BPP to the eUICC, the message transmitted from the FPA to the eUICC according to an embodiment of the disclosure.

A procedure which is not mentioned in the drawings may be equally applied with reference to FIG. 3. The description of FIG. 3 may be applied as description of a reply when a profile is installed in various embodiments of the disclosure.

Before the loading message including the BPP in FIG. 2, an FPA 620 may first transmit information required for BPP installation to an eUICC 625 through a message separated from the loading message including the BPP. This may be, for example, a new ES10f transmission message such as ES10f. PrepareLoading.

In this case, the FPA 620 may receive the BPP together with the information required for BPP installation from the factory IT/OEM 615, configure an ES10f. PrepareLoading message including the required information, and transmit the message to the eUICC 625, and then process BPP transmission to the eUICC 625 according to a processing result thereof as described in FIG. 2. In this case, the FPA 620 may first receive the information required for BPP installation from the factory IT/OEM 615, configure an ES10f. PrepareLoading message including the required information and transmit the message to the eUICC 625, and then additionally receive the BPP from the factory IT/OEM 615 according to a processing result thereof and process BPP transmission to the eUICC 625 as described in FIG. 2.

In the disclosure, an example of the information required for BPP installation may be information including one of otPK.EUICC.KA, credentials of the profile server, a credential chain of the profile server, and an address of the profile server (to which the processing result is transmitted).

When the eUICC 625 receives a message for ES10f. PrepareLoading, the eUICC 625 may process prepare loading in operation 640, configure a processing result message thereof (indicated as a prepare loading response in the disclosure), and transmit the message to the FPA 620 in operation 645. This may be, for example, expressed in the data format shown in [Table 4] below. For example, a message for successful processing may be returned without a signature of the eUICC 625, and a processing error message may be signed with a secret key of the eUICC by the eUICC 625 and transmitted to the FPA 620, including a signature value.

TABLE 4

```
-- ASN1START
PrepareLoadingResponse ::= [33] CHOICE {
  loadingResponseOk PrepareLoadingResponseOk,
  loadingResponseError PrepareLoadingResponseError
}
PrepareLoadingResponseOk ::= SEQUENCE {
  transactionId [0] TransactionId,
  additionalInformation VendorSpecificExtension OPTIONAL
}
EUICCfSigned1 ::= SEQUENCE {
  transactionId [0] TransactionId,
  loadingErrorCode LoadingErrorCode
}
PrepareLoadingResponseError ::= SEQUENCE {
  euiccfSigned1 EUICCSigned1, -- Signed information
  euiccfSignature1 OCTET STRING
}
LoadingErrorCode ::= INTEGER {
  invalidCertificate(1),
  invalidSignature(2),
  installFailedDueToDataMismatch(13),
  unsupportedCurve(123), --
  invalidOid(124),
  ciPKUnknown(125),
  noMoreOtpkFactoryUse(126),
  undefinedError(127)
}
-- ASN1STOP
```

When an error occurs while prepare loading processing is performed in operation 640, the eUICC 625 may transmit an error message to the FPA 620, discard the corresponding RSP session, and end the procedure. When the corresponding RSP session is discarded, encryption keys, that is, otPK.EUCC.KA and corresponding otSK.EUICC.KA which are not used for the corresponding session may be stored without being deleted. The occurring error may be one of LoadingErrorCode shown in the above table and may be analyzed with reference to description of the Error Code defined in SGP.22. However, installFailedDueToDataMismatch(13) which is not defined in SGP.22 may be analyzed as an error for the case where there is no stored otPK.EUCC.KA or otSK.EUICC.KA that matches received otPK.EUCC.KA, and noMoreOtpkFactoryUse(126) may be analyzed as an error for the case where the eUICC has exhausted all of otSK.EUICC.KA that matches otPK.EUCC.KA to be used for the corresponding session.

The FPA 620 receiving the reply result in operation 645 may optionally perform one of the following operations.

Option 1: when the processing result is successfully received, the result may not be notified to the factory IT/OEM 315 (operation 650) or may not be notified (proceed to operation 660 without operations 650 and 655), and then a message including the BPP is transmitted to the eUICC 325 as the following operation in operation 235 of FIG. 2 and operation 235 and the following procedures in FIG. 2 may be performed (operation 660).

Option 1-1: when the processing result is successfully received and the result is notified to the factory IT/OEM 315 (operation 650), the FPA 620 may explicitly receive a request for a load BPP from the factory IT/OEM 615 (operation 655), proceed to operation 235 of FIG. 2 as the following operation to transmit a message including the BPP to the eUICC 325, and then perform operation 325 and the following procedure in FIG. 2 (operation 660). If at least the BPP is received in operation 630, an indication making a request for the LoadBPP may be additionally transmitted without BPP transmission in operation 655.

Option 2: when the processing result is received as an error, the received error result may be transmitted to the factory IT/OEM 615, the corresponding RSP session may be discarded, and the procedure may end (operation 670).

Option 2-1: although not illustrated in drawings, when the processing result is received as an error, the received error result may be transmitted to the factory IT/OEM 615, and when a message for procedure end is explicitly received again from the factory IT/OEM 615, the FPA 620 may transmit a response message and end the procedure.

As described above, when the FPA 620 transmits the processing result received from the eUICC 625 (received in operation 645) to the factory IT/OEM 615, the factory IT/OEM 615 may perform the following procedure of FIG. 3 to process the following procedure. That is, for example, as one of the corresponding received processing results, that is, the loading results of FIG. 3, a prepare loading response (with error) may be transmitted. When the prepare loading response (with error) is received, the FPA 620 should transfer the corresponding message to the factory IT/OEM 615. If a prepare loading response (with success) is received, the FPA 620 may not transmit the prepare loading response (with success) to the factory IT/OEM 615 as mentioned in operation 1, and accordingly, the factory IT/OEM 615 may generate a BPP loading report that does not include the prepare loading response (with success).

When the prepare loading response (with success) is received, the FPA 620 may transfer the prepare loading response (with success) to the factory IT/OEM 615 as mentioned in option 1 or option 1-1. When the factory IT/OEM 615 receives the corresponding value signed by the eUICC, the factory IT/OEM 615 may perform transmission including information on the BPP loading report generated in the future as described in FIG. 3, and the profile server/server vendor 610 receiving the information may verify the corresponding signature and inform the SP/SP server 605 of the reply result (not shown).

Thereafter, as described in FIG. 3, when the BPP loading report including the prepare loading response (with error) list information is transmitted, the following procedure may perform the operation as described in FIG. 3 (operation 655), which has been described in FIG. 3, and thus the description is omitted in FIG. 6.

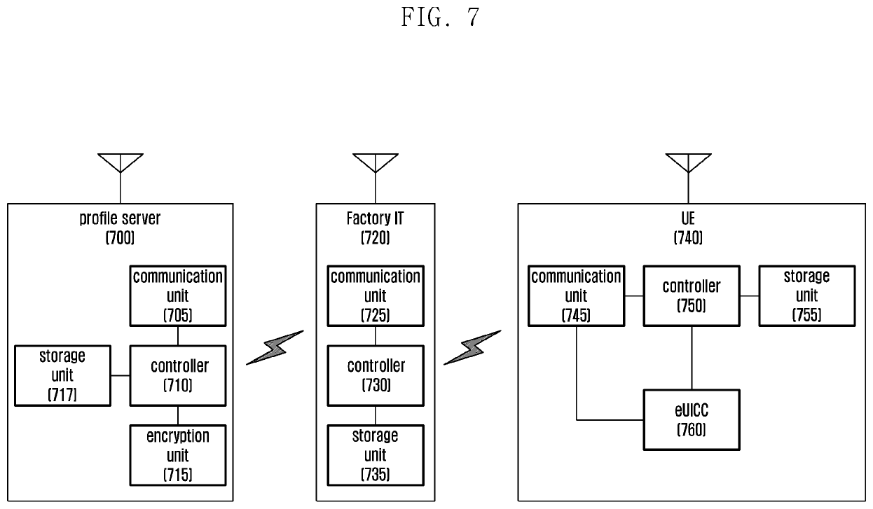

FIG. 7 illustrates a block diagram of the structure of a profile server 700, a factory IT 720, and a UE 740 in a wireless communication system according to an embodiment of the disclosure.

Referring to FIG. 7, the profile server 700 according to an embodiment of the disclosure may include a communication unit 705, a controller 710, and an encryption unit 715. The controller 710 may include at least one processor.

The communication unit 705 may transmit data to other devices or receive data other devices. The communication unit 705 may transmit or receive an encrypted key or an encrypted profile. To this end, the communication unit 705 may include at least one communication module and an antenna.

The controller 710 may control each element of the profile server 700 in order to install a profile according to the disclosure. A detailed operation of the controller 710 has been described above or will be described below. According to an embodiment, the profile server 700 may determine the same orders with reference to information received from a service operator server, manufacturer server, or a service operator and a manufacturer, map the profile and eUICC provision information for the same orders, and the mapped profile and eUICC provision information in a storage unit 717. Further, the profile server 700 may control the operation to map the profile with a specific EID with reference to EID information received from the service operator to prepare the same in advance. According to another embodiment, the controller 710 may perform the operation by determining whether to prepare the profile for IFPP with information received from a message received through the communication unit 705 and processing entry into an operation for preparing the profile.

According to another embodiment, the controller 710 may identify whether the information received from the message received through the communication unit 705 is a profile loading report, transmit each item included in the corresponding report to the encryption unit, make a decision with a result processed through signature verification from the encryption unit, and return information on the processing result to the factory IT 720 and/or the SP/SP server (not shown) through the communication unit 705. According to another embodiment, the controller 710 may identify whether the information received from the message received through the communication unit 705 is a profile loading report, and when information included in the corresponding report does not include eUICC credential information, generate a profile and provide the profile to be used when the used credential information is acquired from the storage unit 717 and the encryption unit 715 processes signature verification.

According to another embodiment, the controller 710 may control the operation of the profile server 700 described in various embodiments of the disclosure.

According to another embodiment, the profile server 700 may receive a message received from the factory IT through the communication unit 705 during a preprocess of preparing and providing a BPP, determine that the received message is a request for downloading profiles for IFPP, process an operation to prepare profiles for factory, and transmit a processing result to the factory IT through the communication unit 705. The encryption unit 715 may encrypt the profiles according to control of the controller 710 to generate a bound profile package, and provide the bound profile package to the controller 710. Some or all of the information received through the communication unit, for example, a profile order ID received from the SP/SP server (not shown) and eUICC credential chain information received from the factory 720 may be stored in the storage unit 717 to verify the BPP loading report.

The encryption unit 715 may include a hardware security module (HSM) or may be named an HSM itself, and may encrypt and decrypt profiles without exposing an encryption key. According to implementation, the encryption unit 715 may be embedded into the controller 710 or implemented in the form of a software code driven by the controller 710.

Referring to FIG. 7, the factory IT 720 according to an embodiment of the disclosure may include a communication unit 725, a controller 730, and a storage unit 735. The factory IT 720 may include a combination of several devices including one or more of the communication unit, the controller, and the storage unit. When several devices are connected to each other, the communication unit may be included in each of the devices for the connection, and a device for centrally controlling each device may be included. The factory IT 720 may include one or more devices as described above. For this, refer additionally to the description of FIG. 1.

Further, according to an embodiment of the disclosure, the communication unit 725 may transmit or receive an encrypted key, an encrypted profile, or the like. To this end, the communication device 725 may include at least one communication module, an antenna, and the like. According to an embodiment of the disclosure, the storage unit 735 and the communication unit 725 may be provided as one device for the factory IT 720 itself. The factory IT 720 may transmit encrypted key information to the profile server 700 through the communication unit 725 for providing a wireless communication connection or receive at least one of encrypted profiles from the profile server 700.

According to an embodiment of the disclosure, the factory IT 720 may transmit a BPP loading report as the profile processing result received from the UE 720 through the communication unit 725 for providing the wireless communication connection or receive the processing result therefor from the profile server 700.

According to an embodiment of the disclosure, the factory IT 720 may transmit the stored encrypted profile to the UE 720 through the communication unit 725, transmit a message making a request for deleting the already installed profile to the UE 720, or transmit a command for deleting notifications generated by the eUICC to the UE 720, and may receive a response message for the processing result from the UE.

According to an embodiment of the disclosure, the factory IT 720 may store the profile received from the profile server 700 through the communication unit 725 or the encrypted key previously acquired from the EUM (not shown) in the storage unit 713 by the controller 730 or transmit the same to a device within the factory IT 720 to perform profile injection through the communication unit 725, and the communication unit 725 of the device within the factory IT 720 performing the profile injection may transmit the same to the UE 740 wiredly or wirelessly.

According to an embodiment of the disclosure, the storage unit 735 of the factory IT 720 may store at least one encrypted profile or encrypted key information for at least one encrypted profile or receive the loading result received from the UE 740. The controller 730 of the factory IT 720 may store the profile loading result received through the communication unit 725 in the storage unit 735 and generate a BPP loading report by using the corresponding information or provide the BPP loading report to the profile server 700 through the communication unit 725 for providing the wireless connection. The storage unit 735 may include storage media in at least one type of a hard disk type, random access memory (RAM), static random access memory (SRAM), read-only memory (ROM), electrically erasable programmable read-only memory (EEPROM), programmable read-only memory (PROM), magnetic memory, a magnetic disk, and an optical disk. According to an embodiment of the disclosure, the factory IT 710 may include several devices as described above, and when the factory IT 710 includes several devices, the communication unit may provide a communication service through access of an external network of the UE manufacturer or access of a network within the UE manufacturer.

According to an embodiment of the disclosure, the controller 730 may include at least one processor. The controller 730 may control the operation of the factory IT 720 according to various embodiments of the disclosure.

Referring to FIG. 7, the UE 740 may include a communication unit 745, a controller 750, a storage unit 755, and an eUICC 760. The eUICC 760 can be removable as described above, but is released while being generally fixed to the UE to be non-removable therefrom and thus is expressed as a portion of the UE 740. The communication unit 745 may receive or transmit data from or to other devices. For example, received data may be one of an encryption key, an encrypted profile, and credential information. Transmitted data may be a response message according to the profile loading result. To this end, the communication unit 745 may include at least one communication module, an antenna, and the like.

According to an embodiment of the disclosure, the controller 750 may control each element of the UE 740 in order to install the profile according to the disclosure. The controller 750 may control overall operations of the UE 740. For example, the controller 750 may transmit and receive signals through the communication unit 745. The controller 750 may record data in the storage unit 755 and read the data. The controller 750 may include at least one processor. For example, the controller 750 may include a communication processor (CP) that performs a control for communication, and an application processor (AP) that controls a higher layer such as an application program. According to an embodiment, when there is configuration information stored in the storage unit 755, the controller 750 may make a request for the configuration information to the storage unit 755, and a screen display unit (not shown) may display the configuration information or receive the configuration information and process an additional operation.

According to another embodiment, the controller 750 may record the data read through the storage unit 755 or match information collected through the controller 750 and the communication unit 745, and perform a processing process of the UE for inferring information that can be referenced for profile installation selection at the factory. The controller 750 may control the UE 740 to perform an operation corresponding thereto. According to an embodiment, the controller 750 may include an FPA that drives and controls the eUICC 760, an application integratively implemented by the FPA, and an application that manages factory installation. The controller 750 may include a UE framework that analyzes information received by the FPA or the application to process a communication processor (CP)-specific command APDU request or collects some or all of the requested information from the storage unit 755 and returns the same to the FPA or the application.

According to an embodiment of the disclosure, the controller 550 may determine an operation of entering the IFPP mode, based on predetermined information acquired from the eUICC 760 through the UE 740 and the communication unit 745 and control the eUICC 760 to enter the IFPP. The eUICC 760 may operate according to the control of the controller 750. According to an embodiment of the disclosure, the eUICC 760 may process a request for installing the profile received from the controller 750 and return the processing result to the controller 750.

The controller 750 according to an embodiment of the disclosure may receive profile information of a profile package received from the factory IT 720 or a response message and determine whether to install the profile in the factory mode with reference to UE settings or user input information during reception, determine entry into the IFPP mode, or configure a message to be transmitted to the eUICC 760 to install the profile in the IFPP. The controller 750 may configure profile information of the profile package through one or more messages and perform control to transmit the message including the profile information to the eUICC 760 or detect generation of an error during a profile installation process and transmit a request for a cancel session to the eUICC 760. The controller 750 may receive the processing result received by the UE 740 from the eUICC 760 or determine whether to end the procedure and perform control to store the processing result in the storage unit 755, transmit the processing result to the communication unit 745, or control the UE 740 to transmit the processing result to the factory IT 720 through the communication unit 745.

According to an embodiment of the disclosure, the controller 750 may determine whether to further transmit a command for additionally deleting the notification to the eUICC 760 through the message received through the communication unit 745 or further acquire the processing result from the eUICC 760 as the result according to the determination, and transmit the processing result to the factory IT 720 through the communication unit 745.

The storage unit 755 may store data such as a basic program, an application program, configuration information, and the like for the operation of the UE 740. In an embodiment of the disclosure, the storage unit 755 may include at least one storage medium among a flash memory type, a hard disk type, a multimedia card micro type, a card type memory (for example, an SD memory, an XD memory or the like), a magnetic memory, a magnetic disk, an optical disk, a random access memory (RAM), a static RAM (SRAM), a read-only memory (ROM), a programmable read-only memory (PROM), and an electrically erasable programmable ROM (EEPROM). The storage unit 755 may be integratively implemented by the controller 750 and a system on chip (SoC). The controller 750 may perform various operations by using various programs, content, data, and the like stored in the storage unit.

In FIG. 7, the eUICC 760 may perform functions of storing, managing, and deleting at least one profile through a UICC chip embedded into the UE 740. The profile may refer to data information such as one or a plurality of applications and subscriber authentication information stored in the existing UICC card, a phone book, and the like. The eUICC 760 may be included as a portion of the UE 740 as illustrated in FIG. 1, and is expressed as separate modules to describe the operations of the UE 740 and the eUICC 760 in FIGS. 2 to 6. The eUICC 760 may include a controller, a storage unit, and a communication unit in order to install the profile. Some of the applications within the eUICC 760 may be installed in the controller 750, and the installed applications may include some of the functions of the FPA.

According to an embodiment of the disclosure, after acquiring profile installation request or deletion request information through the message of the UE 720 received through the communication unit, the controller of the eUICC 760 may process the profile installation or deletion, return the loading result according to the installation or deletion, generate a pending notification after deletion processing and store the pending notification in the storage unit, determine whether to additionally delete the generated pending notification, or delete the pending notification according thereto and respond to a response message. The controller of the eUICC 760 may determine whether to enter the IFPP through information within the received message or a new function defined for IFPP to determine the operation, and accordingly compare a profile installation or deletion procedure for IFPP and the received information with the information in the storage unit of the eUICC 760, and verify and process the same. For example, when a command for the profile installation request is received, the controller may verify the received profile package, perform an operation for the installation, sign the processing result, and return the processing result to the UE 740 through the communication unit. As described in the embodiments of the disclosure, an example of the information compared with the information in the storage unit of the eUICC 760 and verified and processed through the controller 750 may be information indicating whether there is otPK.EUICC.KA used for profile installation or deletion, a transaction ID mapped to a session, and credential information of SM-DPf.

However, the elements described in FIG. 7 are not limited to the above-described example. For example, the factory IT 720 may include elements larger than or fewer than the above-described elements. For example, the profile server 700 may include elements larger or fewer than the above-described elements. For example, the UE 740 may include elements larger or fewer than the above-described elements. The UE 740 according to various embodiments of the disclosure may be an electronic device, and the electronic device may be various types of devices. The electronic device may include, for example, a portable communication device (for example, a smartphone), a computer device, a portable multimedia device, a portable medical device, a camera, a wearable device, or a home appliance device. The electronic device according to an embodiment of the disclosure is not limited to the above-described devices.

Various embodiments of the disclosure separately describe operations of the FPA, the LPA, and the eUICC, but are only for convenience of description and it should be noted that the operations of the FPA, the LPA, and the eUICC may be described as the operations of the UE. For example, the transmission/reception operation of the FPA may be described as the transmission/reception operation of the UE.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first device in a wireless communication system, the method comprising:
transmitting, to a terminal, a first message for a request of a process of a profile;
receiving, from the terminal, a second message including a result of the process of the profile;
generating a bound profile package (BPP) loading report based on the result of the process of the profile; and
transmitting, to a profile server, the BPP loading report,
wherein the BPP loading report is generated based on a profile order identity (ID).

2. The method of claim 1,
wherein the result of the process of the profile includes address information of the profile server to which the result of the process of the profile is to be delivered, and
wherein the BPP loading report includes the profile order ID.

3. The method of claim 1,
wherein the result of the process of the profile includes a profile installation result or a cancel session response, in case that the request of the process of the profile is an installation request, and
wherein the result of the process of the profile includes other signed notification, in case that the request of the process of the profile is a memory reset of the profile.

4. The method of claim 1,
wherein the BPP loading report includes at least one of a profile installation result list, a cancel session response list, an other signed notification list, or a prepare loading response list.

5. The method of claim 1, further comprising:
receiving, from the profile server, a message including a verification result of the BPP loading report,
wherein the first device corresponds to a device that controls installation of the profile during a manufacturing process of the terminal.

6. A method performed by a profile server in a wireless communication system, the method comprising:
transmitting, to a first device, a first message including information for installing a profile;
receiving, from the first device, a bound profile package (BPP) loading report including a result of a process of the profile;
transmitting, to the first device, a response message based on a reception of the BPP loading report; and
verifying the BPP loading report based on a profile order identity (ID).

7. The method of claim 6,
wherein a verification of the BPP loading report is not performed, in case that the BPP loading report includes the profile order ID and the profile order ID is invalid, and
wherein a second message indicating an error is transmitted to the first device, in case that the profile order ID is not included in the BPP loading report.

8. The method of claim 6,
wherein, in case that the BPP loading report includes the result of the process of the profile or other signed notification, a verification of a signature of an embedded universal integrated circuit card (eUICC), a verification of an integrated circuit card identifier (ICCID), and a verification of a sequence number are performed for verifying the result of the process of the profile or the other signed notification, and the verification of the signature of the eUICC is performed based on a eUICC certificate and a certificate chain that are received from the first device before receiving the BPP loading report, and
wherein, in case that the BPP loading report includes a cancel session response, the verification of the signature of the eUICC is performed for verifying the cancel session response, and the verification of the signature of the eUICC is based on the eUICC certificate and the certificate chain included in the BPP loading report.

9. The method of claim 6,
wherein a transaction identifier and encryption key information related to a list included in the BPP loading report are deleted, in case that a verification of the BPP loading report is successful.

10. The method of claim 6, further comprising:
transmitting, to the first device, a third message including a verification result of the BPP loading report,
wherein the first device corresponds to a device that controls installation of the profile during a manufacturing process of a terminal.

11. A first device in a wireless communication system, the first device comprising:
a transceiver; and
a controller configured to:
transmit, to a terminal, a first message for a request of a process of a profile,
receive, from the terminal, a second message including a result of the process of the profile,
generate a bound profile package (BPP) loading report based on the result of the process of the profile, and
transmit, to a profile server, the BPP loading report,
wherein the BPP loading report is generated based on a profile order identity (ID).

12. The first device of claim 11,
wherein the result of the process of the profile includes address information of the profile server to which the result of the process of the profile is to be delivered, and
wherein the BPP loading report includes the profile order ID.

13. The first device of claim 11,
wherein the result of the process of the profile includes a profile installation result or a cancel session response, in case that the request of the process of the profile is an installation request, and
wherein the result of the process of the profile includes other signed notification, in case that the request of the process of the profile is a memory reset of the profile.

14. The first device of claim 11,
wherein the BPP loading report includes at least one of a profile installation result list, a cancel session response list, an other signed notification list, or a prepare loading response list.

15. The first device of claim 11,
wherein the controller is further configured to receive, from the profile server, a message including a verification result of the BPP loading report, and
wherein the first device corresponds to a device that controls installation of the profile during a manufacturing process of the terminal.

16. A profile server in a wireless communication system, the profile server comprising:
a transceiver; and
a controller configured to:
transmit, to a first device, a first message including information for installing a profile,
receive, from the first device, a bound profile package (BPP) loading report including a result of a process of the profile,
transmit, to the first device, a response message based on a reception of the BPP loading report, and
verify the BPP loading report based on a profile order identity (ID).

17. The profile server of claim 16,
wherein a verification of the BPP loading report is not performed, in case that the BPP loading report includes the profile order ID and the profile order ID is invalid, and
wherein a second message indicating an error is transmitted to the first device, in case that the profile order ID is not included in the BPP loading report.

18. The profile server of claim 16,
wherein, in case that the BPP loading report includes the result of the process of the profile or other signed notification, a verification of a signature of an embedded universal integrated circuit card (eUICC), a verification of an integrated circuit card identifier (ICCID), and a verification of a sequence number are performed for verifying the result of the process of the profile or the other signed notification, and the verification of the signature of the eUICC is performed based on a eUICC certificate and a certificate chain that are received from the first device before receiving the BPP loading report, and
wherein, in case that the BPP loading report includes a cancel session response, the verification of the signature of the eUICC is performed for verifying the cancel session response, and the verification of the signature of the eUICC is based on the eUICC certificate and the certificate chain included in the BPP loading report.

19. The profile server of claim 16,
wherein a transaction identifier and encryption key information related to a list included in the BPP loading report are deleted, in case that a verification of the BPP loading report is successful.

20. The profile server of claim 16,
wherein the controller is further configured to transmit, to the first device, a third message including a verification result of the BPP loading report, and
wherein the first device corresponds to a device that controls installation of the profile during a manufacturing process of a terminal.
